(19) United States
(12) Patent Application Publication
(10) Pub. No.: US 2021/0293674 A1
(43) Pub. Date: Sep. 23, 2021

(54) Systems and methods for cryopreservation of biomaterials

(71) Applicant: Regents of the University of Minnesota, Minneapolis, MN (US)

(72) Inventors: Li Zhan, Saint Paul, MN (US); Shuang-Zhuang Guo, Minneapolis, MN (US); Shweta Narayan, Minneapolis, MN (US); Cari Dutcher, North Oaks, MN (US); Michael McAlpine, Minneapolis, MN (US); Kanav Khosla, Minneapolis, MN (US); John Bischof, St. Paul, MN (US)

(21) Appl. No.: 17/262,126

(22) PCT Filed: Jul. 11, 2019
(86) PCT No.: PCT/US2019/041366

§ 371 Date: Jan. 21, 2021

Related U.S. Application Data
(60) Provisional application No. 62/702,037, filed on Jul. 23, 2018.

(51) Int. Cl. G01N 1/42; B01L 7/00; G01N 1/28; G01N 1/44; B01L 3/02; B01L 3/00

(52) U.S. Cl. CPC G01N 1/42; B01L 7/50; G01N 1/2806; G01N 1/44; B01L 2200/0652; B01L 3/502761; B01L 2300/0819; B01L 2300/023; B01L 2200/143; B01L 3/022

(57) ABSTRACT

A cryopreservation system for biological samples is provided. Tire cryopreservation system includes a cooling platform 100 with a 3D printing device that enables a “pick and print” method for processing biological samples 140 for cryopreservation. A syringe or syringes 110 in the 3D printing device picks up biological samples and prints them into a cryogenic environment. A sorting station 200 sorts vitrified samples from unvitrified samples. A warming platform 300 warms the samples using a laser warming system. The cryopreservation system with the sorting station and warming platform are configured for high throughput. Methods for cooling, sorting and warming the biological samples in a high throughput manner are also provided.

This invention was made with government support under OD024430 and EB020537 awarded by the National Institutes of Health. The government has certain rights in the invention.

### BACKGROUND

Preservation of biological material is valuable in many areas including for genetic research, aquaculture development, and biodiversity preservation. Cryopreservation of germplasm of many important species is currently not possible. Examples include the embryos and oocytes of several vertebrate models such as Zebrafish and Xenopus laevis, and many endangered species (e.g. coral and turtles). Over the past decade, for example, researchers have increasingly studied and modified the genetic backbone of the vertebrate model system of the Zebrafish.

The need to preserve germplasm has also become especially urgent in aquatic ecosystems due to coastal pollution, over-fishing, climate change, and acidifying oceans. Today, about 80% of marine fish stocks are over-exploited, and researchers now list freshwater fish species as one of the most threatened group of vertebrates on the planet. An important way to safeguard these unique and endangered species will be the creation of frozen germplasm banks, which can retain viability for years (or even centuries) without DNA damage. More specifically, these banks offer samples of preserved and protected genetic pools that can be used to ‘seed’ shrinking populations all over the world. Additionally, it allows for easy and inexpensive transport of genetic materials among living and/or managed populations. Finally, it vastly improves access to biomaterials and model organisms for scholarly research.

Maintaining all of these valuable genotypes is expensive, risky, and beyond the capacity of even the largest stock centers. Moreover, the difficulty and expense of transporting live colonies make multi-institutional research rare.

### SUMMARY

In a first aspect, the present description relates to a cryopreservation system with a cooling platform. The cooling platform includes a syringe holder, the syringe holder including one or more syringes, each syringe with a tip configured to pick and print a biological sample, the syringe coupled to a pressure dispenser wherein the tip of the syringe picks up the biological sample when the pressure dispenser exerts upward pressure from the tip toward the base of the syringe and prints the biological sample into a cryogenic environment when the pressure dispenser exerts downward pressure toward the tip and/or releases the upward pressure toward the base of the syringe. The syringe can be movably engaged within the syringe holder to move from a pick position to a print position. The biological sample may be printed onto a fibrous wicking material resting on the surface of a highly conductive material. The highly conductive material may be resting in cryogenic coolant. The highly conductive material may be selected from copper, aluminum, silver, or materials coated with copper, aluminum or silver. The fibrous wicking material may absorb moisture and reduce the moisture absorbed by the biological sample. The syringe and the tip may be polypropylene. The biological sample may be selected from a single cell, multiple cells, aggregates of cells, germplasm, embryos or oocytes. The biological sample may be selected from zebrafish embryos, pancreatic islets, Xenopus oocytes, C. Elegans, germplasm, coral germplasm, mammalian, bacteria or protozoa. The biological sample may be at least 0.01 mm in diameter. The biological sample may be a droplet of at least about 0.1 μl. The biological sample may be a droplet between about 0.1 μl and about 40.0 μl. The biological sample can include laser absorbers and/or cryoprotective agents. The cooling platform may be a high throughput system including two or more syringes with tips for picking and printing multiple biological samples. The system may further include a sorting station. The sorting station can sort the biological samples and separate vitrified biological samples from crystallized biological samples, wherein the sorting station may include a microfluidics based sorting device with channels sized for flow of the samples in a fluid, a light source and a detector. The sorting may be performed prior to the freezing of the biological sample. The sorting may be performed when the biological sample is at a cryogenic temperature. The system may include a warming platform. The warming platform can include a cryoscoop for removing the biological sample from a cryogenic environment. The warming platform can further include a laser for warming the biological sample at a cryogenic temperature to a desired temperature. The laser may warm the biological sample in 1-30 milliseconds to room temperature. The cryoscoop may be reusable.

In another aspect, the present description relates to a sorting station. The sorting station can sort biological samples and separate vitrified biological samples from unvitrified biological samples. The sorting station can include a sorting device with channels sized for flow of biological samples in a fluid, a light source and a detector. The sorting station may also include a pressurized air tank operably connected to the detector and a buffer reservoir wherein the detector can detect a vitrified sample from a unvitrified sample and the pressurized air tank operably connected to send a pulse of pressurized air to the buffer reservoir through an airline resulting in a pulse of buffer fluid entering the channel in the sorting station to alter the pathway of the biological sample in the channel closest to the distal end of the pulse of the buffer fluid. The sorting station may separate the vitrified samples and the unvitrified samples into different channels. The sorting station can be a microfluidics based sorting station. The sorting may be performed prior to the freezing of the biological sample. The sorting may be performed when the biological sample is at a cryogenic temperature.

In a further aspect, the present description can include a warming platform. The warming platform can include a cryoscoop for removing the biological sample from a cryogenic environment. The warming platform can further include a laser for warming the biological sample at a cryogenic temperature to a desired temperature. The laser may warm the biological sample in 1-30 millisecond to room temperature. The cryoscoop may be reusable.

In another further aspect, the present description relates to a method for cryopreservation of a biological sample. The method can include picking up the biological sample with a syringe having a tip, wherein the syringe is engaged in a syringe holder of a cooling platform, the syringe coupled to a pressure dispenser wherein the tip picks up the biological sample when the pressure dispenser exerts upward pressure from the tip toward the base of the syringe. In other words, the biological sample associates with the tip due to the upward pressure within the syringe and tip. The method also includes printing the biological sample wherein the sample is printed when the pressure dispenser exerts downward pressure toward the tip and/or releases the upward pressure toward the base of the syringe. The biological sample can be printed into a cryogenic environment. The cooling platform may be a high-throughput system including one or more syringes. The method may include cryopreserving about 20-400 biological samples in about 1 minute. The cooling rate may be about 1000 to about 10,000 ° C./min. The biological sample can be printed onto a fibrous wicking material resting on the surface of a highly conductive material and wherein the highly conductive material and the fibrous wicking material are at a cryogenic temperature. The highly conductive material may be resting in cryogenic coolant. The highly conductive material may be selected from copper, aluminum, silver or materials coated with copper, aluminum or silver. The fibrous wicking material may absorb moisture and reduce the moisture absorbed by the biological sample. The syringe and the tip may be polypropylene. The biological sample may be selected from a single cell, multiple cells, aggregates of cells, germplasm, embryos or oocytes. The biological sample may be selected from zebrafish embryos, pancreatic islets, Xenopus oocytes, C. Elegans, germplasm, coral germplasm, mammalian, bacteria or protozoa. The biological sample may be at least 0.01 mm in diameter. The biological sample may be a droplet of at least about 0.1 μl. The biological sample may be a droplet between about 0.1 μl and about 40.0 μl. The biological sample may include laser absorbers and/or cryoprotective agents. The cooling platform may be a high throughput system including two or more syringes with tips for picking and printing multiple biological samples. The method may include applying pressure when vitrified or crystallized samples are detected by a detector to separate the vitrified biological samples from the crystallized biological samples.

The method can include sorting the biological samples by sorting and separating vitrified biological samples from crystallized biological samples. The method can include sorting with a microfluidic sorting system. The sorting station can be a microfluidics based sorting station and may include channels for passage of the samples in a fluid, a light source and a detector. The method can include sorting prior to cooling the biological sample to a cryogenic temperature. The method can include sorting after freezing the biological sample to a cryogenic temperature.

The method can include warming the cryopreserved biological sample with a warming platform. The warming method can include incubation of the biological sample at room temperature. The warming method can include removing the biological sample from a cryogenic environment by a cryoscoop. The warming method can include laser assisted warming. The laser assisted warming method may warm the biological sample in about 1-30 milliseconds from a cryogenic temperature to room temperature. The warming rate may be about 400,000-24 million ° C./min. The warming platform may be a high-throughput system including multiple cryoscoops.

### BRIEF DESCRIPTION OF THE DRAWINGS

FIG. 1A is a simplified block diagram of a cooling platform of a cryopreservation system.

FIG. 1B is a schematic diagram of one exemplary embodiment of a pick and print device printing an embryo to a cryogenic copper dish.

FIG. 1C is a schematic diagram of a top view of a high-throughput syringe holder.

FIG. 2A is a simplified block diagram of a sorting station of a cryopreservation system.

FIG. 2B is one exemplary embodiment of a schematic diagram of microfluidic optical sorting device for vitrified and crystallized embryos.

FIG. 3A is a simplified block diagram of a warming platform of a cryopreservation system.

FIG. 3B is a schematic diagram of a laser-warming device of a sample with a cryoscoop.

FIG. 3C is a schematic diagram of convective warming for vitrified CPA droplet.

FIG. 3D is a schematic diagram of laser warming method for vitrified CPA droplet.

FIG. 3E shows photographs of the undesirable crystallization that occurs in convective warming, but not in laser warming.

FIG. 4A is a schematic diagram of components of a “pick and print” cryopreservation system showing a droplet printed directly to liquid nitrogen which leads to vitrification failure. A photograph (middle) and an X-ray diffraction (XRD) image (right) of the crystallization of the CPA droplet (1.2 mm diameter, 2 M propylene glycol+1 M trehalose±3 OD GNP) when printed directly into liquid nitrogen are also shown.

FIG. 4B is a schematic diagram components of a “pick and print” cryopreservation system showing a droplet printed onto cryogenic copper dish which leads to vitrification success. A photograph (middle) and an XRD image (right) of the vitrification of the same CPA droplet as in FIG. 4A but when printed onto cryogenic copper dish are also shown.

FIGS. 4C, 4D and 4E are photographs of vitrified droplets without islets, vitrified droplet with islets and non-vitrified droplets with islets, respectively.

FIG. 5A is a photograph of the cryopreservation system of the embryo “pick & print” system. This embodiment includes a custom-built 3D printer, a pressure dispenser, and a high precision tip.

FIG. 5B is an optical image of a printed droplet falling from the tip.

FIG. 6A is a photograph of microfluidic device with fitted tubing.

FIG. 6B is a photograph of droplets flowing in mineral oil in a 200 μm wide microfluidic channel Dark frozen droplets are circled compared to lighter unfrozen droplets.

FIG. 7 is a flowchart of one embodiment of a method of cryopreservation of a biological sample described herein.

FIG. 8 is a plot of the laser fluence rate obtained for the 1064 nm laser by varying input voltages from 155V to 400V (10V increments) and pulse width from 0.5 ms to 20 ms (0.5 ms increments to 5 ms, and 1 ms increments till 20 ms).

FIG. 9 is a plot showing the minimum laser fluence rate required to melt a single 1 microliter droplet containing 2M propylene glycol and 1M Trehalose but varying concentrations GNR. It shows that amount of laser power decreases with increasing gold concentration.

FIGS. 10A-10C are schematic diagrams of a high throughput laser warming setup.

FIGS. 11A-11C are plots of a simulation of the temperature distribution in a droplet at different GNR concentrations.

FIG. 12A is a plot of the effect of laser energy and droplet volume on cell viability.

FIG. 12B is a plot of the effect of laser energy and the concentration of the gold nanorods (GNR) concentration on cell viability.

FIG. 12C is a bar graph of the cell viability in samples after use of different warming protocols.

FIGS. 13A-D are schematic drawings of a perspective, side view, top view and bottom view, respectively, of a cryoscoop.

### DETAILED DESCRIPTION OF ILLUSTRATIVE EMBODIMENTS

The present description is directed to systems and methods for cryopreservation of biological materials and warming of biological materials. The cryopreservation system includes a cooling platform. The cooling platform can include a 3D printing device. The 3D printing device can enable a “pick and print” method for processing biological samples by picking/lifting a biological sample from its environment, e.g. at room temperature, and printing the sample into a cryogenic environment. The cryopreservation system may also include a microfluidic sorting station and/or a warming platform. In one embodiment, the cryopreservation system is a high-throughput system and includes a high-throughput cooling platform, a high-throughput sorting station and/or a high throughput warming platform.

High-throughput cryopreservation of biological material, for example, cells and aggregates (i.e. pancreatic islets), embryos or oocytes (i.e. other vertebrate biomedical models) and commercially relevant or endangered species (i.e. agriculture, aquaculture and biodiversity) can be performed using the systems and methods described herein. Cryopreservation of germplasm of aquatic species is increasingly vital for biomedical research, aquaculture and maintenance of biodiversity. In some exemplary embodiments, biological material that can be cryopreserved can include, for example, embryos and oocytes of fish and amphibians. Well-established, reproducible cryopreservation of biological material can provide a unique opportunity to preserve and expand the use of important biological material.

Although methods are known for cryopreservation of small biological samples, i.e. less than about 0.1 μl droplets, cryopreservation of larger samples has been challenging. Problems related to crystallization of the droplets can adversely affect the sample and/or destroy the sample. Crystallization of the biological sample during cooling and/or warming can lead to disruption of the cellular membranes and other structures that can destroy the integrity of the sample. Similarly, when warming cryopreserved biological samples, i.e. greater than 0.1 μl, uneven warming can lead to destruction in the integrity of the sample and lower sample survival rates.

Cryopreservation can allow viable cells and tissues to be preserved over time in the hypothermic, frozen, or vitrified (glassy) state. This disclosure describes systems, compositions and methods that may be used to cool biological samples and warm cryopreserved biological samples from cryogenic temperatures. The systems, methods and compositions described herein are useful in, for example, cooling millimeter-sized cryopreserved biological samples such as, for example, zebrafish embryos, marine germplasm, and/or other 10 micrometer to millimeter-sized model systems such as, for example, mammalian cells, pancreatic islet cells, stem cells, biopsies of tissues, etc. (0.1 μl to 40 μl droplets).

The cryopreservation systems described herein advantageously can be used in methods to process biological samples for long-tem storage by cryopreservation and also rewarming of the cryopreserved material. High-throughput techniques can be adapted for processing a large number of samples during cryopreservation, sorting and warming. The cryopreservation systems can use optical and/or laser technology for sorting, manipulation, analysis and warming of cryopreserved tissues. Biological samples that are greater than about 0.1 microliter droplets or greater than about 1 micrometer (1 μm) can advantageously be cryopreserved using the methods described herein. Biological samples less than about 0.1 microliter of droplets or less than about 1 micrometer may also be cryopreserved using the methods described herein.

The systems described herein can be used to attain the critical cooling rates (CCR) and critical warming rates (CWR) needed for physical (no crystallization) and biological (no toxicity) cryopreservation success in larger biological samples. The systems and methods described herein can preserve and restore the integrity of the biological samples upon warming. The cooling of the biological sample can result in vitrification of the sample. In one embodiment, this description is directed to systems and methods that can include cooling and warming platforms that can achieve sufficiently high CCRs and CWRs to produce live zebrafish embryos (800 μm) post-cryopreservation.

### DEFINITIONS

Various terms are defined herein. The definitions provided below are inclusive and not limiting, and the terms as used herein have a scope including at least the definitions provided below.

The terms “preferred” and “preferably”, “example” and “exemplary” refer to embodiments that may afford certain benefits, under certain circumstances. However, other embodiments may also be preferred or exemplary, under the same or other circumstances. Furthermore, the recitation of one or more preferred or exemplary embodiments does not imply that other embodiments are not useful, and is not intended to exclude other embodiments from the inventive scope of the present disclosure.

The singular forms of the terms “a”, “an”, and “the” as used herein include plural references unless the context clearly dictates otherwise. For example, the term “a tip” includes a plurality of tips.

Reference to “a” chemical compound refers one or more molecules of the chemical compound, rather than being limited to a single molecule of the chemical compound. Furthermore, the one or more molecules may or may not be identical, so long as they fall under the category of the chemical compound.

The terms “at least one” and “one or more of” an element are used interchangeably, and have the same meaning that includes a single element and a plurality of the elements, and may also be represented by the suffix “(s)” at the end of the element.

The terms “about” and “substantially” are used herein with respect to measurable values and ranges due to expected variations known to those skilled in the art (e.g., limitations and variability in measurements).

The terms “and/or” means one or all of the listed elements or a combination of any two or more of the listed elements.

The terms “comprises,” “comprising,” and variations thereof are to be construed as open ended—i.e., additional elements or steps are optional and may or may not be present.

Unless otherwise specified, temperatures referred to herein are based on atmospheric pressure (i.e. one atmosphere).

“Cryopreservation” as referred to herein relates to preservation of a biological sample at cryogenic temperatures. Cryopreservation includes cooling/freezing the biological sample below subzero temperatures in order to shut down metabolic/chemical activity which can provide long term storage of biomaterials. Cryopreservation of a biological sample may also include warming the biological sample to recover the function activity of the biological sample.

“Cryogenic” or “Cryogenic temperature” as referred to herein relates to a temperature below sub-zero. Cryogenic temperature can be from −80° C. (112° F.) to absolute zero (−273° C. or −460° F.).

“Cryogenic coolant” as referred to herein relates to a substance that is at a cryogenic temperature, e.g. liquid nitrogen, slush nitrogen.

“Pick” and/or “picking” as referred to herein relates to association of a biological sample with a syringe tip when pressure is exerted upward from the tip through the syringe toward the base of the syringe. The upward pressure enables the sample to be associated and remain associated with the syringe tip as the syringe moves, for example, from a pick position to a print position. The sample may be associated by being completely within a syringe and/or the syringe tip, partially outside of the syringe tip, substantially outside of the syringe tip or completely outside of the syringe tip.

“Print” and/or “Printing” as referred to herein relates to releasing or depositing a biological sample. The sample, for example, can be deposited or released into a cryogenic environment. The releasing or depositing of the biological sample can occur when the upward pressure from the tip to the base of the syringe is released or if there is downward pressure applied through the syringe from the base of the syringe toward the tip of the syringe.

“Cryoscoop” as referred to herein relates to a cryoresistant tool that can handle a biological sample. The cryoscoop can, for example, remove a sample from a cryogenic environment. The biological sample may also rest or reside in the cryoscoop during a warming protocol.

“Vitrification” as referred to herein relates to a biological sample that has attained a glassy, amorphous structure when cryopreserved. Vitrified samples have less 0.1% V/V of ice crystallization in the sample.

“Crystallized” sample as referred to herein relates to a biological sample that has attained some crystalline structure and may not produce a viable biological sample upon warming to room or physiological temperature. Crystallized samples may also be referred to herein as unvitrified samples or non-vitrified samples. These terms are used interchangeably herein.

“Sorting” as referred to herein relates to identifying vitrified samples from unvitrified samples and separating the vitrified samples from the unvitrified samples. The separation can be performed, for example, by altering the path of the samples such that vitrified samples are directed to a different destination, e.g. channel, than unvitrified samples.

“High-throughput” as referred to herein relates to the use of automation of a system to rapidly process a large number of samples in short amount of time.

“Germplasm” as referred to herein relates to living genetic resources that are maintained for the purpose of animal and plant breeding, preservation and other uses.

“Biological specimens” or “biological samples” are used interchangeably and as referred to herein relate to cells, germplasm, cell aggregates (i.e. pancreatic islets), embryos, oocytes and the like. The germplasm can be from a variety of species including, for example, coral germplasm, mammalian germplasm and the like. The biological samples can be unicellular organisms such as bacteria, protozoa and the like. The embryos and oocytes can be, for example, from fish, amphibians, mammals, humans and other vertebrates. The biological samples can be related to commercially relevant or endangered species (i.e. agriculture, aquaculture and biodiversity).

Biological samples can include other components to aid in the cryopreservation process, e.g. cryopreserving agent, laser absorbers such as gold nanorods and the like and/or buffer or other media that are present when the biological sample is prepared, transferred and/or cryopreserved. The size of the biological sample may be characterized by volume as a droplet. The droplet, for example, includes the biological sample. The droplet may further include cryoprotective agent(s), laser absorbers, a buffer or media and/or other agents to aid in the cryopreservation. The size of the biological sample may be characterized by the diameter of the biological sample or specimen and/or the volume of the droplet.

In the following detailed description of illustrative examples, reference is made to specific embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the examples in which they are incorporated, do not limit other embodiments, and any reference to the elements, operation, and application of the examples serve only to define these illustrative examples. Features or elements shown in various examples described herein can be combined in ways other than shown in the examples, and any such combinations is explicitly contemplated to be within the scope of the examples presented here. The following detailed description does not, therefore, limit the scope of what is claimed.

All patents, publications or other documents mentioned herein are incorporated by reference.

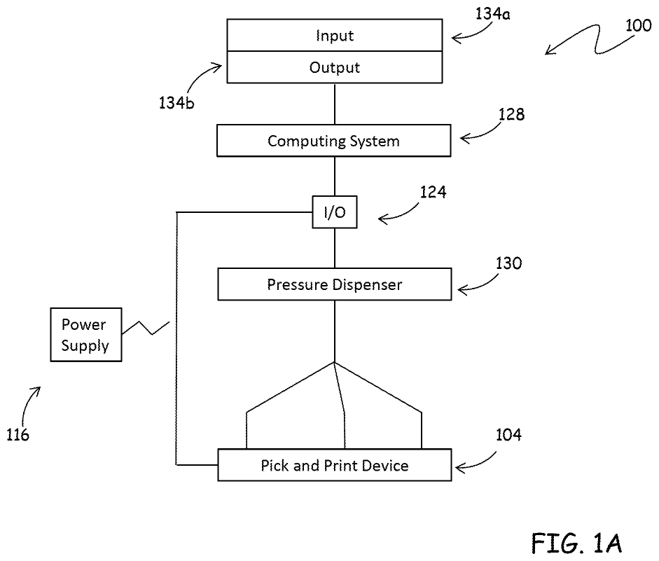

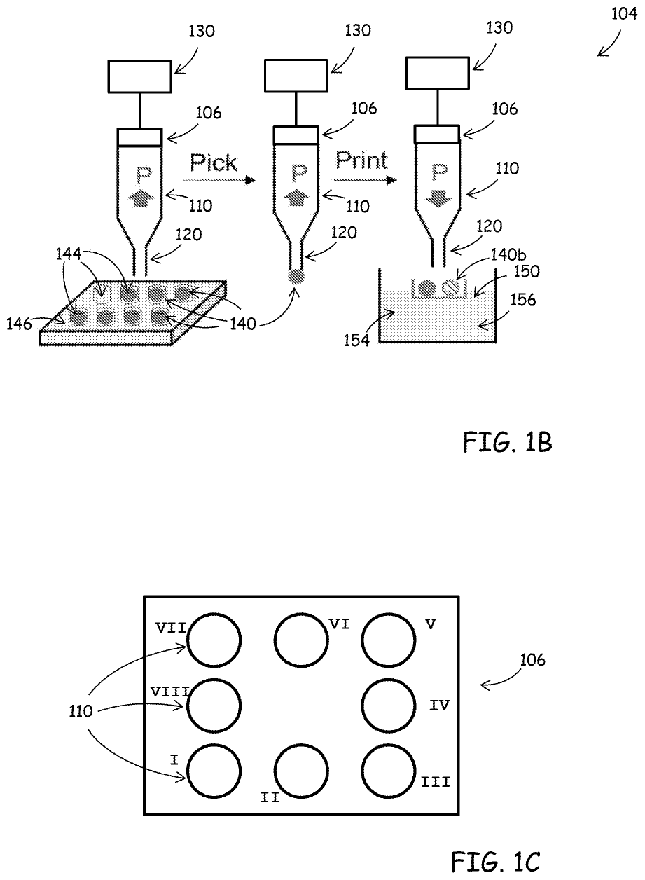

In one embodiment, the present description includes a cryopreservation system with a cooling platform for cryopreservation of a biological sample. FIG. 1A is a simplified block diagram of an exemplary embodiment of cooling platform 100. FIG. 1B is a schematic diagram of one exemplary embodiment of a “pick and print” 3D print device for cooling platform 100. Cooling platform 100 includes 3D print device 104 that includes syringe 110 with tip 120 engaged or movably held within syringe holder 106. In one embodiment, tip 120 is a high precision tip. Cooling platform 100 can include pressure dispenser 130 that can exert pressure within and/or through syringe 110. Pressure dispenser 130 can be operably connected to exert either upward pressure, downward pressure or no pressure on syringe 110. Pressure dispenser 130 may exert pressure downward from base of syringe 110 towards tip 120 as shown, for example, in FIG. 1B when printing sample 140. Pressure dispenser 130 may exert pressure upward from tip 120 to the base of syringe 110 as shown, for example, in FIG. 1B when picking up sample 140. Printing may also occur when the upward pressure is released by pressure dispenser 130 and there is no longer sufficient pressure upward to associate sample 140 to tip 120.

Syringe 110 can be used to pick up sample 140 resting in media 146. In one exemplary embodiment, sample 140 can be an embryo and media 146 can be embryo media. Tip 120 can pick up droplet 144. Droplet 144 can include sample 140 and surrounding media 146. In one embodiment of a pickup setup, syringe 110 and tip 120 are purchased from Nordson EFD, East Providence, R.I. Syringe 110 can be made from a polypropylene blend (3cc, 47012074, EFD). Tip 120 attached to the syringe can be made of stainless steel, for example, with an inner diameter of 0.41 mm (#7018281, EFD). Tip 120 made from other materials such as polyethylene, nylon, or glass with various diameters can also be employed and maybe attached, for example, to syringe 110 through luer lock threaded hubs for the pick-up process. Sample 140 can include biological material and agents to aid in the cryopreservation process such as cryopreservation agents, laser absorbers as described in further detail below.

Pressure dispenser 130 is calibrated to exert upward pressure from tip 120 through syringe 110 toward the base of syringe 110 when tip 120 contacts sample 140 in media 146 to pick up sample 140. The upward pressure provided by pressure dispenser 130 at tip 120 and the surface tension between media 146 and tip 120 can enable syringe 110 to pick sample 140 in droplet 144 from media 146 by providing sufficient pressure for sample 140 to maintain association to tip 120 as shown, for example in FIG. 1B. Syringe 140 can slide or move from media 146 toward cryovessel 154 in order to print sample 140 into a cryogenic environment. Sample 140 associated with tip 120 can be then printed in a desired manner. Printing of sample 140 can include changing the direction of the pressure from pressure dispenser 130 to exert downward pressure toward tip 120 that can release sample 140. Printing of sample 140 can also include release of the pressure from pressure dispenser 130. The lack of upward pressure can release sample 140 from tip 120.

In one embodiment of a high-throughput 3D printing device, syringe holder 106 can include multiple stations or positions, notated as I, II, III and so on in FIG. 1C, to engage multiple syringe(s) 110. FIG. 1C is a top view of one exemplary embodiment of syringe holder 106 in a high-throughput embodiment of cooling platform 100. Syringe holder 106 can include multiple positions, I, II, III, IV, and so on, for positioning multiple syringes 110 at each of the positions. These multiple syringes can be configured to “pick” sequentially and/or simultaneously. Syringes can be continuously circulating through each of the positions in a continuous manner. In one embodiment, syringe(s) 110 are positioned at each of the positions. Pressure dispenser 130 and syringe(s) 110 in syringe holder 106 are configured in a manner that a first syringe at position I can pick up a sample and is conveyed to position II after sample pickup. Syringes can sequentially and/or continuously move through each of the positions in syringe holder 106. Another position, for example, position III, can be configured to be the printing position. When, for example, a first syringe 110 enters the printing position, e.g. position III, the first syringe 110 can print sample 140. After printing sample 140, the first syringe 110 at position III can be conveyed to the next position and continue to cycle through the positions in syringe holder 106 until the first syringe arrives back at position I to pick up another sample 140. In one embodiment, all of the positions include syringe(s) 110 and as a first syringe moves to a second position, a second subsequent syringe can be conveyed to position I to pick up another sample and so on. At any given time, a syringe at position I can pick up a sample and a syringe at position III can print a sample and syringes at other positions are conveyed through syringe holder 106 until they arrive at the pick or print positions to carry out either the pick task or the print task. FIG. 1B exemplifies one “pick” syringe and one “print” syringe.

In one embodiment, a first syringe 110 can be at position I placed over samples 140. When pressure dispenser exerts upward pressure in syringe 110 at position 1, sample 140 associates with tip 110. After association with tip 110, first syringe 110 can move to position II with associated sample 140. When the first syringe moves to position II while maintaining the upward pressure from the pressure dispenser, a second syringe may move to position I in order to pick up another sample 140. The first syringe 110 may be further conveyed to position III while maintaining the upward pressure and the second syringe may be conveyed to position II while a third syringe enters position I. Syringe 110 at position III can have access to a cryogenic environment. In one embodiment, in position III, syringe 110 and tip 120 associated with sample 140 can be over cryovessel 154 with coolant 156 as shown in FIG. 1B in order to print sample 140 into a cryogenic environment. Sample 140 can be released in position III into a cryogenic environment upon exertion of downward pressure from the pressure dispenser through syringe 110 at position III. The specific position in the syringe holder where the samples are picked up by a syringe and the specific position in the syringe holder where the samples are printed into a cryogenic environment can vary. The number of positions between the “pick” aspect and the “print” aspect of the 3D printing device can vary and all are within the scope of this description. In a high-throughput system, a cooling platform can include two or more syringes, five or more syringes, 10 or more syringes and all are within the scope of this description.

In the embodiments of simultaneously picking up, multiple syringes can be configured to “pick” simultaneously and conveyed to multiple print positions. All syringes 110, in position I, II, III and so on, in syringe holder 106 can be placed over samples 140 at the same time. When pressure dispenser exerts upward pressure in syringes 110 at all the positions, many samples 140 associate with tips 110. Then syringes 110 can be moved to a printing position while maintaining the upward pressure. Samples 140 can be released at the printing position into a cryogenic environment upon exertion of downward pressure from the pressure dispenser through all syringes 110 in syringe holder 106. Hence, multiple syringes can “print” simultaneously for a further high-throughput system.

Many variations in the size and configuration of the syringe holder, number of syringes, location of the pick and print positions are possible and all are within the scope of this description. Embodiments with multiple pick positions and multiple print positions within a syringe holder are also within the scope of this description. Samples can be picked simultaneously or sequentially. Samples can be printed simultaneously or sequentially.

Sample 140 can be printed into or onto a variety of cryogenic environments. Sample 140 may be printed into a cryogenic environment such as vessel 154 that includes cryogenic coolant 156. Cryogenic coolant 156 can include, for example, liquid nitrogen. Cryogenic coolant 156 may also include slush nitrogen. Other cryogenic coolants such as ethanol, methanol, FC 770 oil (3M) may also be used and all are within the scope of this description. In one embodiment, sample 140 can be printed onto cryogenic surface 150 that is at a cryogenic temperature. The cooling of sample 140 can occur to achieve critical cooling rates (CCR) as further described herein.

In one embodiment, cryogenic surface 150 can be a highly conductive material. The highly conductive materials are generally cryoresistant, e.g. maintain integrity at cryogenic temperatures, in order to receive a biological sample. Highly conductive materials that can be used as a cryogenic surface include, for example, copper, silver, aluminum, and the like. The cryogenic surface can also include other materials that are coated with copper, silver, aluminum, and the like. Although cryogenic surface 150 is exemplified in FIG. 1B as a dish, other shapes may also be used as a cryogenic surface. Cryogenic surface 150 may also include a flat surface, e.g. without any sidewalls. Cryogenic surface 150 can include a variety of thicknesses and the thickness is such that the surface receiving sample 140 can be maintained at a cryogenic temperature.

In some embodiments, the highly conductive material may be overlaid by a fibrous wicking material that is also at the cryogenic temperature and sample 140 is printed onto the fibrous wicking material overlaid on the highly conductive material. The fibrous wicking material may be placed or be resting on the highly conductive material to advantageously wick any moisture that may be present in the sample. The fibrous wicking material can be, for example, a fibrous tissue. The thickness of the fibrous wicking material can vary and is within the thickness such that the surface receiving the biological sample can be maintained at a cryogenic temperature. The fibrous wicking material can have a thickness of at least about 0.1 mm. In some embodiments, the thickness of the fibrous wicking material is between about 0.1 mm and about 2 mm. Thickness outside of this range are also within the scope of this disclosure. The highly conductive material may or may not have the fibrous wicking material when a sample is placed in the cryogenic environment.

Sample 140 may be maintained at a cryogenic temperature on cryogenic surface 150. Alternatively, sample 140 may be allowed to enter the cryogenic coolant 156. In one embodiment, sample 140 is printed onto cryogenic surface 150 overlaid with a fibrous wicking material. Printed sample 140 can be allowed to drop into coolant 156 by tilting cryogenic surface 150 in order for sample 140 to roll or drop into coolant 156.

Cooling platform 100 can include other components to carry out the functions of the pick and print device as indicated in a block diagram in an exemplary embodiment shown in FIG. 1A. Syringe 110 with tip 120 are operably engaged in syringe holder 106. Pressure dispenser 130 is operably connected to syringe holder 106 to exert upward or downward pressure to syringe(s) 110 at the desired positions. Operation of system 100 can include input/output (I/O) circuitry 124 to allow, for example, the timing, the amount of pressure, the direction of pressure to be applied by dispenser 130 through syringe 110 and tip 120. Computing system 128, for example, a microprocessor, can be configured for input 134a and/or output 134b in order to execute the cryopreservation process. Input 134a can include, for example, information entered by an end user or a button to initiate the cryopreservation process. Computing system 128 can be coupled through I/O circuitry 124 to control pressure dispenser 130 and/or syringe holder 106. Computing system 128 can activate pressure dispenser 130 to control the direction of pressure, the amount of pressure in a syringe and the timing of pressure applied through a syringe. The direction of the pressure may be upward from the tip of the syringe towards the base of syringe, for example, when picking up a sample. The direction of the pressure may be downward from the base of the syringe toward the tip of the syringe, for example, when printing a sample. In some embodiments, the pressure dispenser may release the upward pressure after picking up a sample to print the sample. In other words, printing may occur when the pressure dispenser applies little downward pressure or no pressure. I/O circuitry 124 can include, for example, digital-to analog converters, analog-to-digital converters, switchable outputs, etc. Power supply 116 is provided and can be, for example, a portable power sources such as a battery, a non-portable power source or the like. The power supply may be a rechargeable either through connection to another electrical power source, a solar cell or the like.

Input/output circuitry 124 is also illustrated coupled to computing system 128. Computing system 128 can be a microprocessor. This may include any type of input or output device including a display, keyboard or manual input, audible output, digital output such as a USB or Ethernet connection, an RF (radio frequency) or IR (infrared) input and/or output, a cellular data connection, an Ethernet connection, etc. Example RF connections include but are not limited to BLUETOOTH® connections or other short distance communication techniques, WIFI connections, or others. Cellular phone connections allow the device to communicate using a cellular phone network for communicating data and/or providing optional voice communication.

In some embodiments, the cryopreservation system may also include a sorting station. The sorting station can include a sorting device that can be used to sort viable and/or vitrified biological samples from non-viable, unvitrified and/or crystallized biological samples. Sorting may be conducted prior to cryopreservation, after cryopreservation and/or proceeding the warming of the cryopreserved sample. Sorting station may be a standalone device. Alternatively, it may be coupled or integrated to a cooling platform and/or a warming platform. In one embodiment, the sorting station is coupled to the cooling platform such that samples that have been cooled to a cryogenic temperature are conveyed to the sorting station to identify and separate the vitrified samples from crystallized or partially crystallized samples.

In some embodiments, the viability of the samples can be determined to eliminate non-viable, unvitrified biological samples. Prior to freezing, viable, vitrified biological samples may be selected using any suitable method including, for example, manual selection, centrifugation, or flow cytometry.

In one embodiment, the sorting device can include a microfluidic system that could allow for high throughput optical sorting of viable versus non-viable specimen at room temperature prior to printing into liquid nitrogen. Sorting of biological samples prior to freezing has been described, for example, in WO2017/184721 A1 by Bischof et al. and incorporated herein by reference. The selection of viable samples may be automated in a high-throughput system.

Printing of biological samples into a cryogenic environment can result in a mixture of vitrified and unvitrified or crystallized samples. Vitrified samples are samples that have become solid without freezing and these samples are non-crystalline amorphous solids. Crystallized samples have attained at least some crystalline characteristics and are not conducive to regaining all or substantial amount of biological activity upon warming. A sorting station may be used to separate the vitrified samples from the crystallized or unvitrified samples in order to eliminate the crystallized samples from long-term storage and/or warming. In one embodiment, the crystallized samples may be discarded or separated from the vitrified samples. In one embodiment, the biological samples may be sorted to separate the vitrified and crystallized samples after the biological sample is at a cryogenic temperature. Biological samples described herein may be sorted using a sorting station after the biological samples have been cryopreserved or printed into a cryogenic environment. The biological samples may be sorted using a flow system where the samples flow in a fluid in a channel and each sample is evaluated by a detection system to determine if a sample is vitrified or unvitrified. In one exemplary embodiment, the samples may be sorted based on an optical detection system.

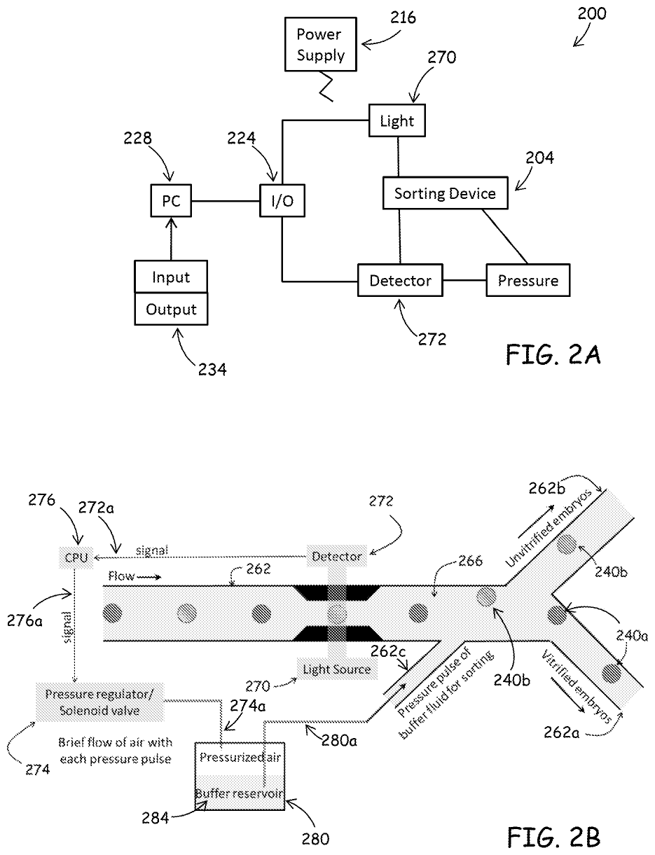

In one exemplary embodiment shown in FIG. 2A and FIG. 2B, a microfluidic optical platform can be used as the sorting device in the sorting station. Samples 240a and 240b are shown as vitrified and crystallized samples, respectively. In FIG. 2A and FIG. 2B, sorting station 200 includes sorting device 204 with channel 262, fluid 266 in channel 262, light source 270, detector 272, and pressure source 274. Channel 262 can have fluid 266 flowing in the direction indicated and have a thickness to accommodate samples 240a and 240b. Channel 262 can also include a forked junction to generate two separate channels 262a and 262b. Channels 262, 262a and 262b are sized to allow flow of samples 240a and 240b in fluid 266. Light source 270 and detector 272 are placed along the flow path of samples 240a and 240b in fluid 266 Channel width may be narrowed at detection to accelerate the flow and space samples further apart during detection. As samples 240a and 240b pass across or past the path of light source 270, detector 272 can ascertain vitrified sample 240a from crystallized sample 240b based on the interaction of light source 270 with samples 240. In one embodiment, light source 270 interacts differently with sample 240a than sample 240b and this difference is detectable by detector 272. Detector 272 is operably connected to pressure source 274. Single or multiple (encoded arrays) detector output signals may be used. When detector 270 detects unvitrified sample 240b, signal 272a can be sent to CPU 276. CPU 276 generates signal 276a to actuate pressure source 274. Signal 272a and 276a can be received and/or transmitted through a wired or wireless connection. Pressure source 274 can calibrate the pressure based on the output of detector 272 to direct vitrified samples 240a into channel 262a and crystallized samples 240b into channel 262b as exemplified in FIG. 2B. In one embodiment, pressure source 274 can include a pressure regulator/solenoid valve. Airline 274a connects pressure source 274 to buffer tank 280 including buffer 284. A brief flow of air with each pressure pulse when detector 272 detects unvitrified sample 240b can be injected into buffer tank 280. Pressurized air from airline 274a in response to a pressure pulse can enter buffer tank 280 and result in pressure pulsing buffer 284 through buffer line 280a into channel 262c. A pulse of buffer fluid 284 into channel 262c can lead to sorting unvitrified embryos 240b by deflection into channel 262b. Alternatively, detector 272 may detect vitrified embryos 262b and send signal 272a upon detection of vitrified samples 262b. In such embodiments, buffer 284 in buffer tank 280 may be pulsed into channel 262c when vitrified samples are detected. Alternate methods of separating vitrified and unvitirified samples may be used and all are within the scope of this description.

In embodiments of cryopreserved biological samples, channels 262, 262a, 262b and 262c include materials that are compatible with cryogenic temperatures. Fluid 266 within channels 262, 262a and 262b can be compatible with the cryogenic temperatures to maintain samples 240a and 240b at a cryogenic temperature and enable samples 240a and 240b to flow through channels 262, 262a and 262b. Fluids can be, for example, FC770 oil (3M) and the like.

In the schematic diagram of an exemplary embodiment shown in FIG. 2B, light source 270 can be, for example, visible light or near infrared that is focused at a position where samples 240a and 240b flow through in channel 262. As samples 240a and 240b pass across the path of light source 270, detector 272 such as a light sensor or an infrared sensor detects a reading and is able to discern if a sample is vitrified or crystallized based on the differing results for sample 240a versus sample 240b. An optional user input 234 is provided. For example, this input can be a single button allowing an operator to initialize a test, or can be a more complex input such as a numerical keypad or of a numeric keypad allowing an operator to update parameters such as threshold values used by station 200. In the simplified block diagram of FIG. 2A, a computer identified as computing system 228 is used to perform the sorting. Computing system 228 can be coupled to light source 270 and detector 272 through I/O circuitry 224. I/O circuitry 224 can include, for example, digital-to-analog converters, analog-to-digital converters, switchable outputs, etc. Single or multiple (encoded arrays) detector output signals may be used.

Although any appropriate components may be employed, in one embodiment, the source 270 comprises a laser, for example a 532 nm green laser (i.e. LRS-0532-PFM_00200-03, LaserGlow Technologies Inc.). Focusing light source 270 can comprise for example a plano-convex focusing lens. A suitable infrared detector includes an infrared camera (A20 or E30, FLIR Inc) or infrared detector (MLX90614, Melexis). However, the present description is not limited to this configuration.

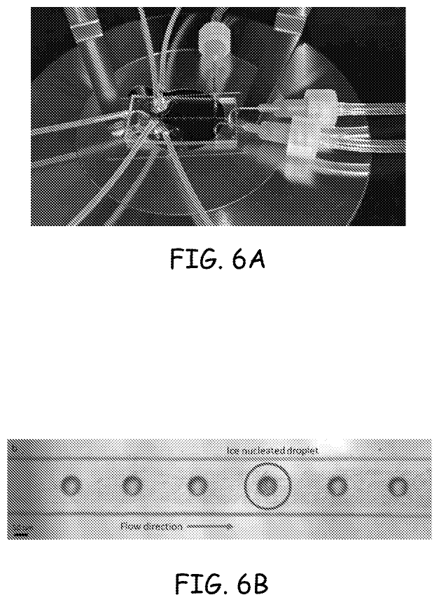

FIG. 6 is a photograph of microfluidic device with fitted tubing (FIG. 6A), and dark frozen (circled) and light unfrozen liquid droplets flowing in mineral oil (FIG. 6B). The microfluidic device with the fitted tubing is from Metcalf, Boyer, and Dutcher, “Interfacial Tensions of Aged Organic Aerosol Particle Mimics Using a Biphasic Microfluidic Platform”, Environmental Science and Technology, 50, 1251-1259, 2016, incorporated herein by reference. FIG. 6B illustrates that an optical detection system can be used to identify and separate vitrified and unvitrified embryos based on opacity.

A variety of appropriate components and configurations may be used as described, for example, in Xi, Heng-Dong et al. “Active droplet sorting in microfluidics: a review. Lab on a Chip, Issue 5, 2017, incorporated herein by reference.

The present description also includes a cryopreservation system with a warming platform. The warming platform can be used to warm the cryopreserved biological sample to room temperature or other physiological temperatures. In other words, the warming platform is used to warm the cryopreserved sample from a cryogenic temperature to a non-cryogenic temperature. The warming platform can be a stand-alone system. Alternatively, the warming platform may be coupled or integrated to a cooling platform and/or a sorting station.

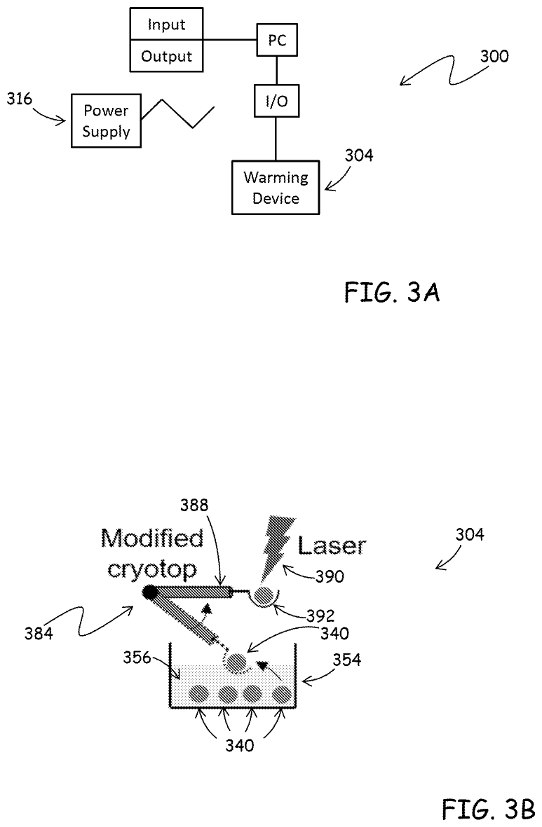

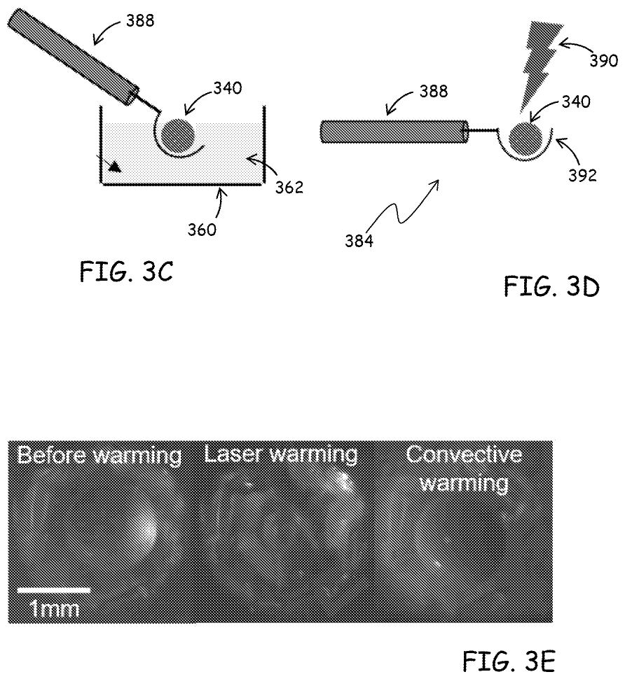

In one exemplary embodiment, warming platform 300 as shown in FIGS. 3A and 3B. In schematic diagram of FIG. 3B, warming device 304 can be used to warm cryopreserved sample 340. Sample 340 can be resting, for example, in cryogenic coolant 356 in vessel 354. Cryopreserved sample 340 can include laser absorbers such as GNRs. Cryoscoop 384 may be used to remove the cryopreserved biological sample. Cryoscoop 384 can include handle 388, and may be modified at the scooping end, for example, as a spoon or ladle, by the addition of scoop 392 in cryoscoop 384 to retain sample 340. Sample 340 in scoop 392 of cryoscoop 384 can be exposed to laser warming by laser 390 after removal from coolant 356 to warm sample 340 to desired temperature, e.g. room temperature or physiologic temperature. The warming of sample 340 can be performed to achieve critical warming rates (CWR) as further described herein.

The present description also includes a high-throughput warming platform. A high-throughput warming platform, for example, can include multiple cryoscoops to process multiple samples. The cryoscoops can be reused once a sample has been warmed appropriately and transferred out of the warming platform into a receptacle in an appropriate environment. Many embodiments of a high-throughput warming platform can be used and all are within the scope of this description.

In FIG. 3B, light source 390 can be, for example, visible light or near infrared that is focused at a position with sample 340. As discussed herein, visible or near infrared light directed at the sample can cause heating of the sample. In the simplified block diagram of FIG. 3A, an optional user input/output 334a/334b is provided. For example, this input can be a single button allowing an operator to initialize a test, or can be a more complex input such as a numerical keypad or of a numeric keypad allowing an operator to update parameters such as threshold values used by station 300. In the configuration of FIG. 3A, a computer identified as computing system 328 is used to perform the warming. Computing system 328 couples to laser source 320 through I/O circuitry 324. I/O circuitry 324 can include, for example, digital-to-analog converters, analog-to-digital converters, switchable outputs, etc.

FIG. 3C shows a schematic diagram of convective warming of sample 340. Cryoscoop 384 with sample 340 is placed in container 360 with embryo media 362 and allowed to reach the desired temperature, e.g. room or physiologic temperature. FIG. 3D shows a schematic diagram of laser warming of sample 340. Cryoscoop 384 with sample 340 in scoop 392 is exposed to laser 390 to warm sample 340 to the desired temperature. FIG. 3E shows photographs of sample 340 prior to warming, after laser warming and after convective warming.

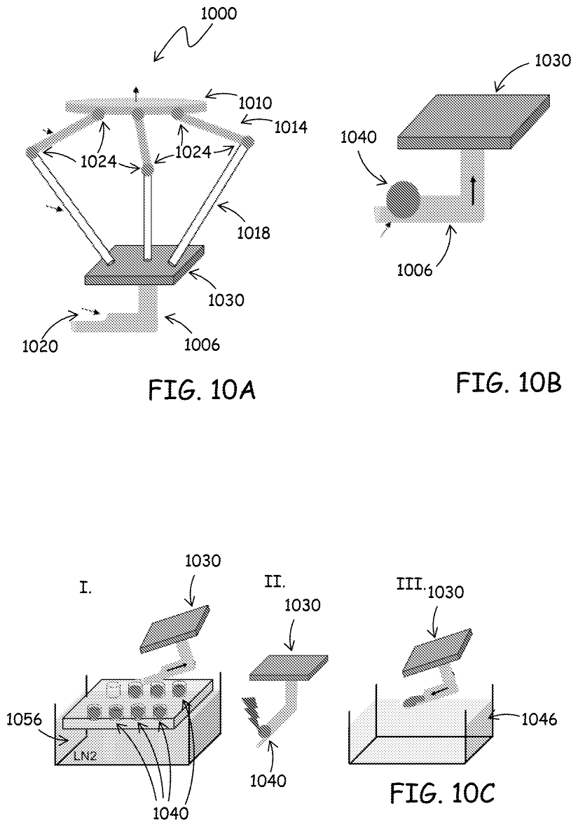

FIGS. 10A-10C show a schematic diagram of one exemplary embodiment of a high throughput laser warming station 1000. In FIG. 10A, warming station 1000, e.g. Delta robot (IRB 360 FelxPicker®, ABB Group), is equipped with scoop 1020 on handle 1006 to manipulate samples 1040 at high speed. In one exemplary embodiment, warming station 1000 may include pressure control 1030 to apply a pressure or vacuum through handle 1006 (in the direction of the arrow). Warming station 100 may also include base 1010 to mount warming station 1000 to a laser chamber. Base 1010 may be connected to pressure control 1030 through upper arms 1014 and lower arms 1018. Upper arms 1014 and lower arms 1018 are flexibly connected through rotatable attachments 1024. Scoop 1020 may be manipulated relative to a laser chamber mounted on base 1010. Base 1010 can move up, down, left, right, back and/or forward relative to scoop 1020 to retrieve and position sample 1040 at a desirable location relative to a laser chamber. In FIG. 10B, scoop 1020 and handle 1006 are connected to pressure control device 1030 to pick up sample 1040. A vacuum may be applied through handle 1006 by pressure control 1030 to provide inward suction or pressure in order to grab and hold sample 1040 in scoop 1020. In FIG. 10C, the process of high throughput laser warming and release into culture media is shown. In FIG. 10C (i), scoop 1020 of warming station 1000 is manipulated to retrieve sample 1040 in cryogenic coolant 1056 with a vacuum provided by pressure control 1030 to attach and retain sample 1040 in scoop 1020. Sample 1040 is removed from cryogenic coolant 1056 and warmed by a laser in scoop 1020 as shown in FIG. 10C (ii). Sample 1040 is then transferred to culture media 1046 and release of the vacuum can release the warmed sample into culture media 1046 as shown in FIG. 10C (iii).

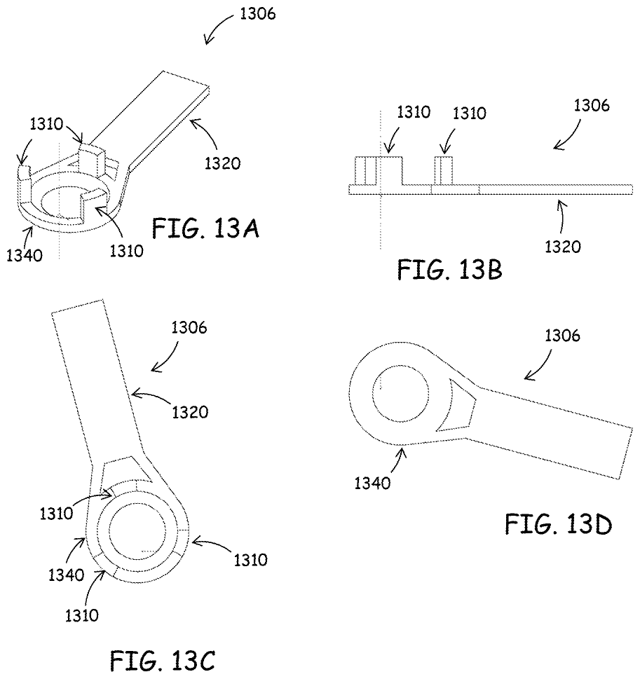

In FIGS. 13A-13D, one exemplary embodiment of scoop 1306 is shown in a perspective view, side view, top view and a bottom view, respectively. Scoop 1306 includes handle 1320 and posts 1310. A sample can be held between posts 1310 in scoop 1306 and resting on base 1340. Base 1340 may include an aperture therethrough for draining any residual liquid and in order for scoop 1306 to retain a sample with minimal (or any) accompanying liquid. Posts 1310 can be protruding up from base 1340 to trap a sample within scoop 1306. Aperture in base 1340 can allow any coolant or other liquid to pass through the aperture allowing a sample to be held in scoop 1306. In other words, scoop 1306 acts as a sieve and holder when a sample is transferred from a liquid, e.g. liquid nitrogen, prior to warming the sample by a laser. The posts 1310 also holds the sample in position (e.g. a cryopreserved sample) when the cryoscoop is lifted rapidly from liquid nitrogen for laser warming. Other embodiments of scoop are possible and are within the scope of this description.

In one embodiment, a cooling platform, a sorting station and a warming platform may each be housed separately. In some embodiments, a cooling platform, a sorting station and/or a warming platform may be housed together. In some embodiments, the cooling platform may be coupled to a sorting station and/or a warming platform in sequence such that the cryopreserved sample may be transported to the sorting station such that vitrified and crystallized samples can be separated. In some embodiments, the sorting station may be connected in sequence to a warming platform such that cryopreserved samples that are vitrified after cryopreservation may be conveyed to enter the warming platform. Any combination of the cooling, sorting and warming components may be housed together and/or may be operably connected for processing the biological samples.

A variety of biological samples can be cryopreserved according to the systems and methods described herein. Biological samples can include human cells (e.g., pancreatic islet cells, HDF cells, stem cells, biopsy samples, etc.), mouse oocytes, zebrafish embryos, Xenopus laevis oocytes, coral larvae, or Lepidochelys olivacea embryos. In some embodiments, the sample can include germplasm—e.g., from a biopsy taken from a testis or an ovary from any animal or species. In other embodiments, however, any tissue sample that can be loaded with a cryoprotective agent and metal-containing laser absorber can be used in connection with the systems described herein. Exemplary alternative samples include, for example, neural cells, ganglia, stem cell spheroids, any biopsy from any soft tissue within the size parameters listed in the immediately preceding paragraph. If the laser beam can be broadened, additional exemplary samples include, for example, the cornea, skin, or other thin tissues. While described herein in the context of an exemplary embodiment in which the biological sample is a zebrafish embryo, the systems and methods described herein can be applied to a variety of materials.

The biological material can be any millimeter-sized biomaterial. In some embodiments, the term millimeter-sized sample can have a smallest linear dimension of less than about 5 mm. In one embodiment, the sample can be less than about 4 mm. In one embodiment, the sample can be less than about 3 mm. In one embodiment, the sample can be less than about 1 mm. In one embodiment, the sample can be less than about 0.5 mm In one embodiment, the sample can be less than about 0.1 mm. In some embodiments, the biological sample can be between about 0.01 mm and about 2.0 mm.

The biological material can be any microliter-sized biomaterial droplet. In some embodiments, the microliter-sized sample can have a volume of less than 40.0 μl. In one embodiment, the microliter-sized sample can have a volume of less than 10 μl. In one embodiment, the microliter-sized sample can have a volume of less than 1 μl. In one embodiment, the microliter-sized sample can have a volume of less than 0.5 μl. In one embodiment, the microliter-sized sample can have a volume of less than 0.1 μl. In some embodiments, the microliter-sized sample can have a volume of between 0.1 μl and about 40.0 μl.

The biological samples may also include agents to promote cryopreservation. These agents can include, for example, cryoprotective agents and/or laser absorbers. Other agents that aid in the cryopreservation, sorting or warming processes may also be included in the biological sample.

In one embodiment, a composition including a cryoprotective agent and a laser absorber may be microinjected into the biological sample. The cryoprotective agent and/or the laser absorber may be in a medium that is conducive to maintaining the integrity of the biological sample. The medium, for example, can be a buffered medium or solution.

Also, while described herein in the context of an exemplary embodiment in which the cryoprotective agent includes propylene glycol, the composition, systems and methods described herein can involve the use of any suitable cryoprotective agent. Exemplary suitable cryoprotective agents include, but are not limited to, combinations of alcohols, sugars, polymers, and ice blocking molecules that alter the phase diagram of water and allow a glass to be formed more easily (and/or at higher temperatures) while also reducing the likelihood of ice nucleation and growth during cooling or thawing. In most cases, cryopreservative agents are not used alone, but in cocktails. In the case of vitrification solutions, exemplary cryopreservative cocktails are reviewed in Fahy et al., He, Xiaming, et al., Risco, Ramon, et al. and Choi, Jung Kyu, et al. and all incorporated herein by reference. (Fahy et al., Cryobiology 48(1):22-35, 2004; He, Xiaoming, et al. “Vitrification by ultra-fast cooling at a low concentration of cryoprotectants in a quartz micro-capillary: a study using murine embryonic stem cells.” Cryobiology 56.3 (2008): 223-232; Risco, Ramon, et al. “Thermal performance of quartz capillaries for vitrification.” Cryobiology 55.3 (2007): 222-229; Choi, Jung Kyu, Haishui Huang, and Xiaoming He. “Improved low-CPA vitrification of mouse oocytes using quartz microcapillary.” Cryobiology 70.3 (2015): 269-272.) Additional exemplary cryopreservative solutions can include one or more of the following: dimethyl sulfoxide, glycerol, propylene glycol, ethylene glycol, sucrose, trehalose, raffinose, polyvinylpyrrolidone, and/or other polymers (e.g., ice blockers and/or anti-freeze proteins).

In some embodiments, the cryoprotective agent may be present in the composition at various concentrations. In some embodiments, the cryoprotective agent may be present, for example, at a molarity of no more the 6 M such as, for example, no more than 5 M, for example, no more than 4 M, for example, no more than 3 M, for example, no more than 2 M, for example, no more than 1 M, for example, for example, no more than 900 mM, for example, no more than 800 mM, for example, no more than 700 mM, for example, no more than 600 mM, for example, no more than 500 mM, or for example, no more than 250 mM.

While described herein in the context of an exemplary embodiment in which the laser absorber is a gold nanorods, the technology described herein can involve the use of a laser absorber of any suitable geometry and containing any suitable laser absorbing plasmonic material. Generally, the laser absorbing plasmonic material absorbs a narrow band of laser energy in contrast to, for example, India Ink, which is a broad band absorber. Thus, in some embodiments, the laser absorber can include material effective at converting laser energy into heat such as, for example, a metal such as gold, silver, titanium, and/or copper. In other embodiments, the laser absorber can be an alternative plasmonic material such as, for example, graphene. In some embodiments, the laser absorber can include an additional material such as, for example, a silicon core. Thus, the laser absorber can include a plurality of materials generally constructed to include a core and a shell that at least partially covers the core. The particular material or combination of materials used in the laser absorber can be selected based, at least in part, on the particular wavelength of the laser being used to warm the sample. For example, when using a diode laser with a wavelength of 800 nm, the laser absorber can include a gold nanoshell with a silicon core. Similarly, the laser absorber can have any suitable geometry including, for example, a rod shape, a sphere, a cube, a horn, a star, etc. Selection of materials and geometry of the laser absorber can allow broad band absorption of various laser wavelengths from, for example, 200 nm to 2000 nm. Thus, the laser can also be selected to excite at any wavelength suitable to match the absorption of the plasmonically active nanoparticle.

In some embodiments, the laser absorber is distributed throughout all compartments of the cell. For a germinal cell, such a distribution includes the presence of the laser absorber in the chorion and yolk. For a somatic cell, such a distribution includes the presence of the laser absorber in the cytoplasm and the nucleus.

In some embodiments, the laser absorbers are not within the cells but in the exterior of the cells but in the fluid, e.g. media and/or cryoprotective agent, surrounding the cells. In these embodiments, the laser absorbers can be included in the droplet that is cryopreserved and thus the cryopreserved sample includes the laser absorbers and allows for improved laser warming.

The system can incorporate droplet microfluidics to transport cells through the system and/or add regents—e.g., a cryopreservation agent, an excipient, culture medium, metal laser absorber (e.g., gold nanorods), etc.—to the cells prior to the cells being frozen. Multi-phasic droplet microfluidics may be used to introduce a plurality of components to the cells. In addition, once frozen, embryos could be stored and/or transported to a laser warming jig that would quickly move embryos (one at a time) under a laser pulse.

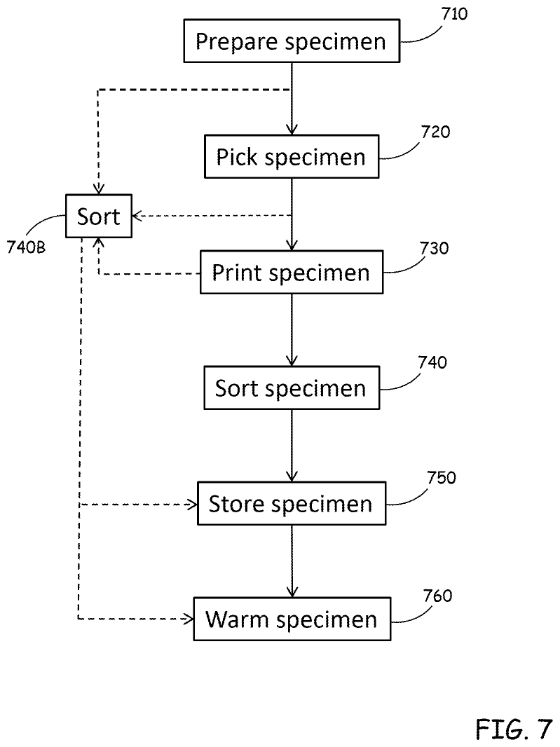

The present description can include methods for cryopreservation of biological samples. The methods may also include sorting and warming biological samples. FIG. 7 illustrates one exemplary embodiment of a schematic flow diagram for method 700 for cryopreservation of a biological sample. FIG. 7 is one embodiment and other methods or variations of methods can also be used and are included in the scope of this description.

At step 710, the method can include preparing a sample for cryopreservation. The preparation can include, for example, treating the sample with agents that can assist in the cooling, sorting and/or warming of the biological sample and preserving the integrity of the biological sample during cooling, sorting and warming steps. In one embodiment, the sample may be treated with cryoprotective agents and/or laser absorbers as described herein. The sample, for example, may by microinjected with one or more cryoprotective agents and/or one or more laser absorbers. The biological sample treated as described herein can be bathed in a media that is amenable to maintaining the integrity of the biological sample.

Maintaining the integrity of the biological sample as used herein relates to preventing cellular membrane from disruption and release of cellular contents due to loss of integrity of the membrane structure. Other forms of disruption of the biological sample that hinders recovery of the biological activity, e.g. crystallization of sample, upon warming after cryopreservation should also be avoided. Other methods of preparing a biological sample may be used and are within the scope of this description.

The method can include step 720 of picking up the biological sample to be cryopreserved. The sample can be picked up by a pick and print device that includes a syringe coupled to a pressure dispenser. The sample can be picked up by the tip of a syringe. A pressure dispenser coupled to the syringe can exert upward pressure from the tip of the syringe toward the base of syringe. The tip of the syringe can be placed over the sample and the upward pressure of the syringe can lead to the association of the sample to the tip. The sample can remain associated with the tip as long as the upward pressure is maintained on the syringe.

The syringe with the sample associated with the tip can be conveyed from the position where the sample is picked up toward a vessel at a cryogenic temperature. The vessel, for example, can include cryogenic coolant, e.g. liquid nitrogen. The syringe with the associated sample can be moved to the desired position over the cryogenic environment. The pressure dispenser can then be manipulated to exert downward pressure from the base of the syringe toward the tip to print or release the sample (step 730) into the cryogenic environment. Alternatively, the pressure dispenser can release the upward pressure from the tip to the base of the syringe. The sample may be placed directly into the cryogenic coolant. Alternatively, the sample may be placed onto a highly conductive material that is in a cryogenic environment, e.g. at a cryogenic temperature. The highly conductive material can be a dish, a plate and the like. The highly conductive material may also be overlaid by a fibrous wicking material and the sample from the syringe tip is printed or placed on the fibrous wicking material. Advantageously, the fibrous wicking material absorbs any moisture present or generated and may reduce the incidence of crystallization with the sample. The printed sample may be placed on the highly conductive surface at a cryogenic temperature. The printed sample may also be allowed to roll or drop into the cryogenic coolant from the highly conductive surface.

The cooling rates of the printed samples in the cryogenic environment can vary and are sufficient to achieve vitrification. In one embodiment, the cooling rate achieves at least the CCR for the sample. The cooling rates can be at least about 1,000° C./min. In some embodiments, the cooling rates can be between about 1,000° C./min and about 10,000° C./min. In some embodiments, the cooling rates can be about 10,000° C./min or faster.

The printed samples may, optionally, be transferred to a sorting station as shown in step 740. The sorting device can also maintain a cryogenic environment as the sample is conveyed through the sorting device. The channels and the liquid in the sorting device can be functional at cryogenic temperatures. In other words, the channel walls and the liquid can tolerate the cryogenic temperatures and the liquid is able to transport the samples at cryogenic temperature. The samples can pass past a light or laser source and a detector is able to determine the presence of vitrified sample or a crystallized sample. Pressure can be released into the tubing upon detection of a crystallized sample leading to the movement of the crystallized sample to a different path than a vitrified sample as illustrated in FIG. 2B. Alternatively, the pressure can be released into the channel upon detection of a vitrified sample leading to the movement of the vitrified sample to a different path than a vitrified sample.

Sorting may also be conducted at other stages of the cryopreservation method. Sorting, for example, can be conducted as indicated in step 740B. A sorting step can be conducted after the preparation step 710 and/or after picking up of the sample, prior to printing the sample, to determine the viability of the sample. Sorting at 740B can generally be done without the sorting device at cryogenic temperatures since the samples have not yet been cryopreserved.

After printing (step 750) or after sorting at (step 740), the samples may be stored at a cryogenic temperature for a desired length of time (step 750). The samples may be stored at cryogenic temperature for any length of time, for example, a fraction of a second, a second, minute, an hour, a day, a month, a year or many years.

Methods of printing, storing and warming specimen may also be conducted without a sorting step and are within the scope of this description.

When a cryopreserved biological sample is needed for a desired purpose, the sample can be retrieved from storage and warmed (step 760). A variety of methods can be used to warm the sample to the desired temperature, e.g. room temperature or physiological temperatures or non-cryogenic temperatures. The sample can be removed from storage by, for example, a cryoscoop. The cryoscoop, for example, may include a well, or a scoop to hold the sample in place as shown, for example, in FIGS. 13A-13D. A laser source can be directed at the biological sample in the cryoscoop.

The cryopreservation methods described herein can lead to retention of a high percentage of the biological activity or cell viability of the biological samples after warming from storage at a cryogenic temperature, e.g. below −80° C. Biologically active can refer to the use of the biological sample in a biological activity that would have been performed prior to cryopreservation. The biological activity of the cryopreserved sample is at least about 50 percent of the activity relative to the activity of the sample prior to cryopreservation. In some embodiments, the biological activity is at least about 60 percent, such as at least about 70 percent, at least about 80 percent, at least about 90 percent, at least about 95 percent of the activity relative to the activity of the prior to cryopreservation.

The laser can be, for example, a near infrared (NIR) laser. The laser, for example, can provide a fluence rate from about 10⁶ W/m² to 10⁹ W/m². Other lasers and fluence rates may also be used and all are within the scope of this description.

The warming rates generated by the laser can vary and are fast enough to maintain integrity of the sample. In one embodiment, the warming rates can achieve the CWR. The warming rates can be at least about 300,000° C./min. In some embodiments, the warming rates can be between about 400,000° C./min and about 24 million °C./min.

In some embodiments, this disclosure includes laser-assisted heating of a composition or biological sample that includes a metal laser absorber such as, for example, gold nanorods. Gold nanorods are efficient for heating and to generate heat uniformly across a sample without toxicity. Thus, laser-assisted heating of a metal laser absorber can generate high heating rates uniformly inside a millimeter-sized biological sample and can be used to rewarm any cryopreserved millimeter-sized biomaterial where the metal laser absorber can be disbursed. This technology can be exploited to allow a biological stock center (e.g., an aquaculture center, germplasm stock center, or a tissue bank) to store and ship vitrified biological samples. The recipient of the vitrified samples can then rewarm the material using the technology described herein so that the material is suitable for, for example, research and/or commercial purposes.

In one embodiment, the survival of zebrafish embryos post cryopreservation can be accomplished by an ultra-rapid nanowarming approach. This approach can include injecting zebrafish embryo with gold nanorods and low-concentration CPA and vitrified in liquid nitrogen. The vitrified embryos are then warmed by laser heating of gold nanoparticles achieving ultra-rapid rates of >10⁶° C./min. Using this approach, reproducible zebrafish embryo cryopreservation results can be attained.

In one exemplary embodiment, zebrafish embryos are microinjected with one or more cryoprotective agents, e.g. polypropylene glycol and/or laser absorbers, e.g. gold nanorods. The gold nanorods and the cryoprotective agents are microinjected into a biological sample. The sample is rapidly cooled to a temperature suitable for frozen storage. To rewarm the sample, the sample can be subjected to a NIR laser pulse.

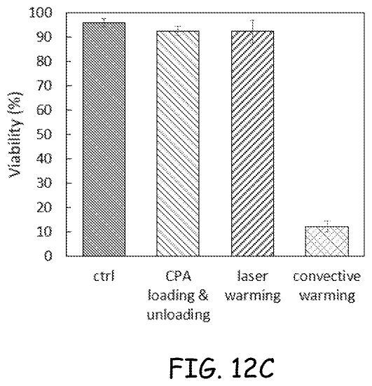

A number of parameters can determine the optimal cryopreservation and warming methods for a desired biological sample. The size of the specimen and the size of the droplets can determine the optimal parameters for a sample. Warming of a cryopreserved sample may vary in the strength of laser to be used and the concentration of the GNRs included in the sample prior to cryopreservation. For example, in some embodiments, a higher concentration of GNRs may be used in cryopreservation and can be offset by the use of a lower strength of laser during laser warming. As shown in FIG. 12B, at each concentration of GNRs, there can be an amount of laser energy that can be applied to the sample and maintain high cell viability. However, after a certain amount, increasing the amount of laser energy can quickly result in reducing the cell viability due to overheating (i.e., boiling the sample). In some embodiments, lower concentrations of GNRs can be used and can be combined with higher laser energy while achieving uniform heating within the droplet and therefore higher cell viability compared to when high concentrations of GNRs are applied. The size of the sample, the amount of desired laser energy to be applied to a sample, the amount of GNRs to be included can vary for each type of sample. An optimal method for cryopreservation and/or laser warming for a sample of interest may be determined by varying the parameters and identifying the desired characteristics for sample of interest.

### EXAMPLES

### Example 1

### High Throughput Islets Cryopreservation Using a Pick and Print System

Islets were printed using the pick and print method with a pick and print system. The system included 8 syringe tips and droplets were printed at a rate of 20 droplets per minute per tip. This resulted in the system generating 160 droplets per minute. Islets were in 2M propylene glycol and 1M trehalose with GNR OD=1.

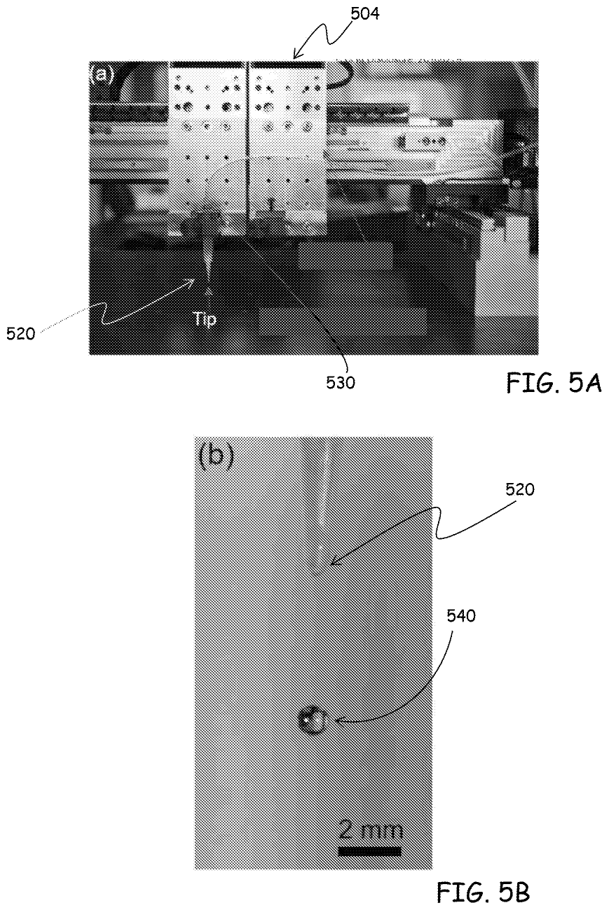

FIGS. 5A and 5B are photographs of the cryopreservation system of the embryo “pick & print” system. This embodiment includes a custom-built 3D printer, a pressure dispenser and a high precision tip. FIG. 5B is an optical image of a printed droplet falling from the tip.

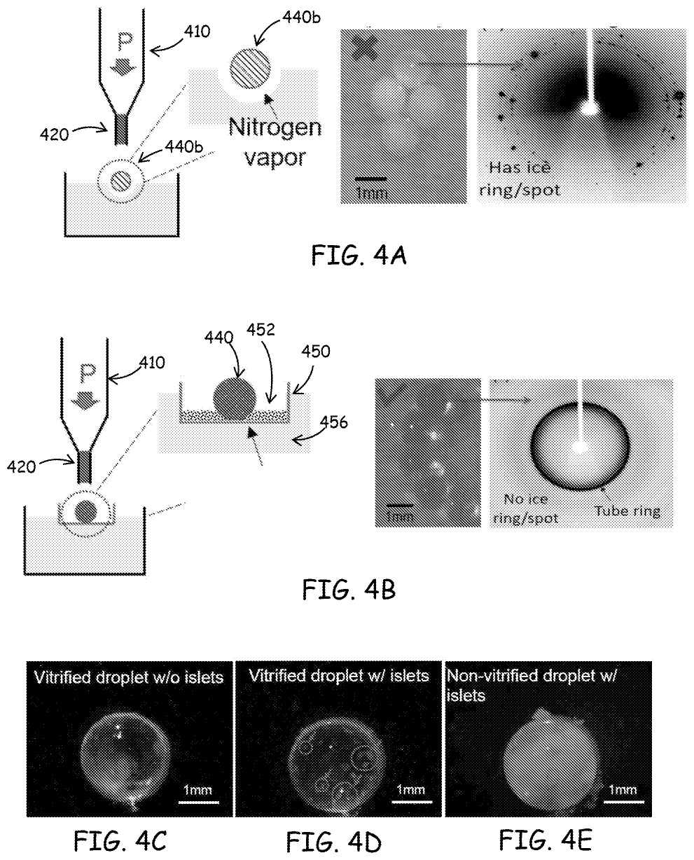

FIGS. 4A-4B are schematic diagrams of components of the cryopreservation system and photographs of the results of cryopreservation of droplet of islets using the “pick and print” system. FIG. 4A is a schematic diagram of crystallization of islets in a CPA droplet (1.2 mm diameter, 2 M propylene glycol+1 M trehalose+3 OD GNP) when printed directly into liquid nitrogen. FIG. 4B is a schematic diagram of the vitrification of the same CPA droplet as in FIG. 4A when printed onto cryogenic copper dish with a wicking paper as shown schematically in FIG. 4B. FIG. 4A and FIG. 4B include photographic images and XRD results at −170° C. of samples printed directly into liquid nitrogen and into a copper dish with a wicking surface, respectively. FIGS. 4C-4E are photographic images of 4 μl droplets with CPA and GNRs (1.2 mm diameter, 2 M propylene glycol±1 M trehalose+3 OD GNP). FIG. 4C is an image of vitrified droplet without islets. FIG. 4D is a vitrified droplet with islets and FIG. 4E is a non-vitrified droplet with islets.

### Example 2

### Cryopreservation of Human Dermal Fibroblast (HDF) Cells Using Pick & Print and Laser Warming of the Cryopreserved Samples

High throughput droplet vitrification and laser warming for HDF cells was performed. HDF cells in 4 μl droplets were cryopreserved using pick-print technology to obtain vitrified samples. The droplets included CPA of 2M propylene glycol and 1M trehalose and various concentrations of GNRs. The vitrified cells were warmed with a laser. Laser warming was performed at a rate of 400,000 to 12,000,000° C./min. Cell viability of the HDF cells was tested after laser warming. HDF cell viability was tested with droplet volumes of 4 μl. Cell viability was examined at varying laser energy and GNR concentrations (OD). Temperature distribution in droplets was also examined at various GNR OD.

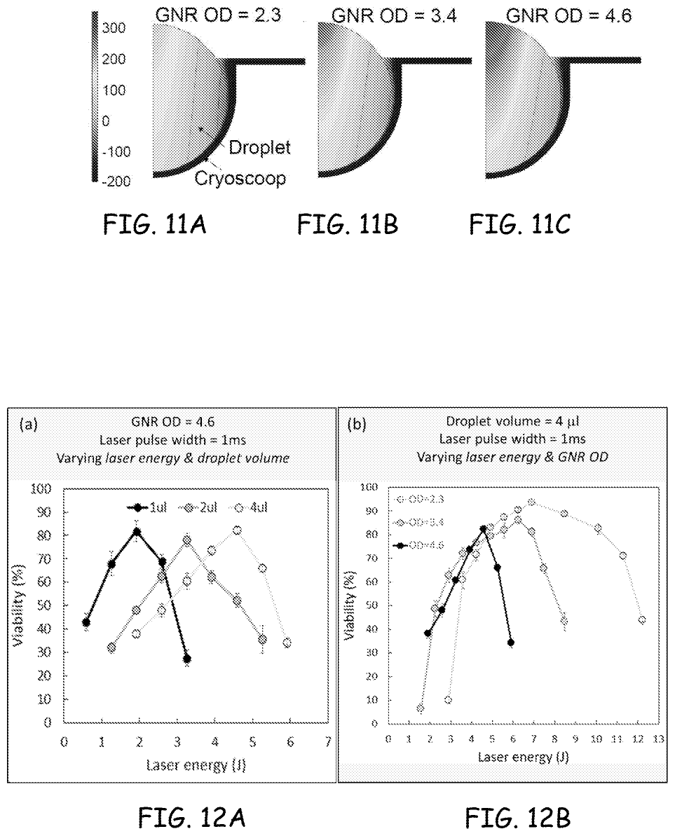

FIGS. 11A-11C show the temperature distribution in droplets at various GNR concentrations (OD). FIGS. 11A-11C show that as the concentration of GNRs increases the amount of energy retained from the laser is greater leading to an increase in the temperature of droplet especially in regions exposed to the laser (as opposed to the droplet face protected by the cryoscoop). FIG. 12A shows the viability of the HDF cells at varying laser energy and droplet volume. The GNR was fixed at GNR OD=4.6 and laser pulse width=1 ms. The viability of HDF cells is affected by the laser pulse energy. Bigger droplets (i.e., 4 μl) need more laser energy compared with smaller droplets (i.e., 1 μl). In FIG. 12B, fixed droplet volume is 4 μl and laser pulse width is 1 ms. Laser pulse energy and GNR concentration determined the cell viability. Lower GNR concentration (i.e., OD=2.3) leads to higher viability than higher GNR concentration (i.e., OD=4.6). In FIG. 12C, comparison of cell viability of control (i.e., untreated), CPA treated along (i.e., no cryopreservation), laser warming and convective warming groups. Droplet size was 4 μl. Laser warming still had high cell viability compared to convective warming.

### Example 3

### Preparation of Zebrafish Embryos for Cryopreservation and Laser Warming

Materials and Methods.

Animal Care and Culture. Wild-type zebrafish (Danio rerio) embryos were obtained from the University of Minnesota Zebrafish Core. All care and welfare for the animals met NIH animal care standards. Full details of approved protocols are listed with the Zebrafish Core-IACUC (protocol #1506-32642A). Zebrafish parent clutches and their embryos were maintained at 28° C. under standard conditions as described in Westerfield.

Microinjection of Cryoprotectant and GNRs. The microinjection of solutions into zebrafish embryos has been well-established in the literature. The high cell stage (t=3 h after fertilization) was chosen to be a robust developmental stage for microinjection while still allowing maximal uniformity of distribution of the injection throughout the embryo. The chorion was not removed in the experiments to mechanically protect the embryo during handling. The embryos were injected laterally through the chorion into the yolk. The volumes of cryoprotectant and GNRs introduced were 9 nL in the yolk and 90 nL into the chorionic space surrounding the embryo. Embryos (n=100 per group) were injected with solutions with N=1.2×10¹⁸ particles/m³ of GNRs, both coated with CTAB and PEG, and 0.2% WV India ink (Higgins Ink, model #HI44-011). Since India ink would plug up the injection needles, a slightly lower concentration was used than what was reported in the literature. All the injected solutions were prepared in standard embryo medium (EM). Embryos for laser warming were microinjected with PG (2 M) and GNR-PEG (N=1.2×10¹⁸ particles/m³) using the same protocol as described above. To test the efficacy of the injection and warming processes, the experimental groups included (i) non-injected non-frozen embryos (n=383); (ii) microinjected (EM alone) nonfrozen embryos tested for toxicity=200): (iii) microinjected (PG and GNRs) nonfrozen embryos tested for toxicity (n=234); (iv) microinjected (PG and GNRs) embryos, frozen and “convectively warmed” (n=50); and (v) microinjected (PG and GNRs) embryos, frozen and “laser warmed” (n=223).

Estimation of SAR. To warm a zebrafish embryo from liquid nitrogen temperatures to room temperature (i.e., ΔT=221° C.) by a laser pulse (τ=1 ms), the required SAR can be estimated as SAR=ρCpΔT/τ=4.4×10¹¹ W/m³, where ρ=990 kg/m³ and Cp=2 kJ/kg K are properties of ice. Since SAR depends on GNR optical properties and laser fluence rate, comparisons were first made between theoretical predictions and experimental results of GNR optical properties. First, the absorption cross section, Cabs, was predicted from the DDA method as previously reported for GNRs and GNPs. Here the dipole density was assumed to be 4 dipoles/nm, and the average of nine different laser GNR orientations (from 0° to 90°) were used to account for random GNR distribution inside the embryo. Next, Cabs was experimentally measured using GNR warming of a GNR solution with a cuvette heating method. This required measuring temperature change resulting from laser warming (1064 nm CW laser. I1064SR0500B, Innovative Photonic Solutions) in a GNR solution (N=3.6×10¹⁸ particles/m³). In all the embryo warming cases, a similar concentration of GNRs (N=1.2×10¹⁸ particles/m³) was injected, and the experimentally determined absorption coefficient (μa=38.9 cm⁻¹) for the embryo was found. From this, the laser fluence rate needed to generate the required SAR (i.e., 4.4×10¹¹ W/m³) was found to be I=SAR/μₐ=1.1×10⁸ W/m². From the laser fluence rate calibration, the operating input conditions capable of generating the required fluence rate were found (see Laser Fluence Rate Calibration in Supporting Information). The required laser fluence rate was verified by testing numerous vitrified droplets of the same size as the embryo under the laser and observing them melting and not refreezing. Very occasionally, refreezing was observed in droplets and embryos presumably due to differential laser absorption between the Cryotop and the GNR-loaded system. In this case, the laser fluence rate was raised by the smallest possible increment of 5 V to achieve melting without refreezing. This was always achieved in ≤4 increments or ≤7.5% total change in voltage from our nominal 270 V setting. Higher reproducibility in GNR loading, Cryotop design, and laser conditions can reduce any possible refreezing even further. The same laser conditions (I=1.2×10⁸ W/m², 1 ms pulse time, N=1.2×10¹⁸ particles/m³) were consistently used in all the zebrafish embryo and HDF warming experiments to generate an adequate amount of heating (SAR).

GNR Distribution. To assess the nanoparticle distribution within the embryos, they were microinjected with fluorescent GNRs (L=110 nm, D=20 nm) coated with Dylight 650 (emission peak at 670 nm) (nanoComposix, San Diego, Calif., USA) and imaged with a fluorescence laser confocal microscope at 640 nm excitation (Nikon C2si, NY, USA). After the initial convection from the microinjection, the GNRs continued to move by passive diffusion for 3-4 h prior to imaging.

Embryo Survival Analysis. Twelve hundred embryos were examined at different time points after microinjection for survival. The selected time points were 1 h, 3 h, 24 h, and 5 days after microinjection (for toxicity tests). For the first three time points, embryos were considered alive if they were developing and moving within the chorion between consecutive time points. At the day 5 time point, an embryo was considered normal in development if it had hatched and was able to swim upright in the water column, had proper cardiac development, eye and tail musculature development, fins, and a functional swim bladder. Any fish that did not match these criteria was considered abnormal in their development and a failed survival.

Cooling and Laser Warming Experiment. Recent studies measured cooling rates of 69 000° C./min or higher for a liquid nitrogen cooling 0.1 μl droplet on a Cryotop (Kitazato Corp., Fuji, Japan). Since the critical cooling rate for vitrification of 2 M PG is 50 000° C./min and the Cryotop can exceed it, the Cryotop was chosen for this study. As the commercially available Cryotop is only 0.4 mm wide, it was not wide enough for a zebrafish embryo (D>1 mm, considering the chorion), and modifications were made to extend the width of the polypropylene blade to 1.5 mm. Simulated cooling rates with this modified design suggest rates more than 50 000° C./min are possible, and this approach was used in all subsequent embryo cooling.

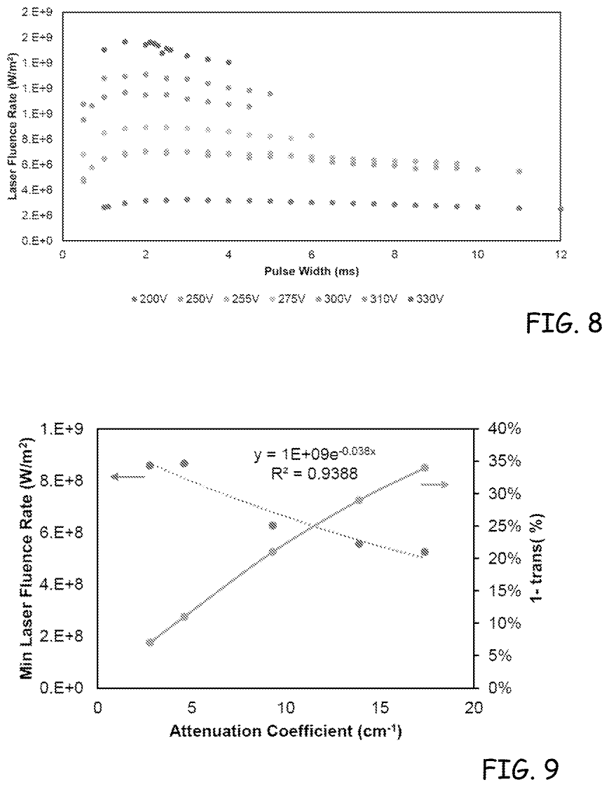

To move embryos for vitrification rapidly into the liquid nitrogen and quickly bring them from the liquid nitrogen under the laser beam, a pick and print system with a sorting station and a warming platform with a cryoscoop as described herein can be used. The embryos can be pick and printed into a copper dish with a wicking surface in liquid nitrogen. The embryo was held in liquid nitrogen until successfully cryopreserved at liquid nitrogen temperatures and analyzed for vitrification. In rare cases, embryos would turn white or opaque, suggesting ice crystal formation during cooling, and these were discarded. After equilibration, the embryos were quickly and reproducibly moved to a position of focus under the laser beam such that warming could be achieved in one laser pulse. The movement was initiated only after the optimal laser parameters had been validated such as voltage, pulse time, and spot size to achieve the fluence rate to produce the warming rates needed. FIG. 8 is a plot of Laser fluence rate calibration for 1064 nm laser. Fluence rates were calculated by using a power meter to measure energy per pulse for different voltage and pulse width conditions. The spot size fixed to the maximum of 2 mm. The average value of 3 trials is reported here (standard deviation was less than 0.1% for all points).

FIG. 9 is a plot showing the minimum laser fluence rate required to melt a single 1 ul droplet containing 2M propylene glycol and 1M Trehalose but varying concentrations GNR. The attenuation coefficient is proportional to the number of GNR in the droplet. It also shows that amount of laser power that would be absorbed by the droplet base on Beers law.

Specifically, one laser pulse at 270 V, 1 ms pulse time, and 2 mm spot size were used to warm embryos. The laser fluence rate provided by the laser was determined characterization of Laser Fluence Rate to be approximately 1.1×108 W/m2.

After the laser warming, the cryoscoop can be removed and the embryo can be placed into embryo medium for further analysis. For the convective warming case (n=50), microinjected embryos were cooled as before with the modified Cryotop into liquid nitrogen. However, after equilibration, the embryos were immersed into embryo medium at 25° C. for warming. The experimental and control groups were then cultured at 28° C. and monitored regularly up to day 5.

Additional details for methodology related to cryopreservation and laser warming are in Khosla et al. “Gold Nanorod Induced Warming of Embryos from the Cryogenic State Enhances Viability” ACSNANO July 2017, incorporated herein by reference in its entirety including the supplementary information and Khosla et al, “Characterization of Laser Gold Nanowarming: A Platform for Millimeter-Scale Cryopreservation Langmuir 2019, 35, 23, 7364-7375, also incorporated herein by reference.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

What is claimed is:

1. A cryopreservation system comprising:
a cooling platform comprising a syringe holder, the syringe holder comprising one or more syringes, each syringe with a tip configured to pick and print a biological sample, the syringe coupled to a pressure dispenser wherein the tip of the syringe picks up the biological sample when the pressure dispenser exerts upward pressure from the tip toward the base of the syringe and prints the biological sample into a cryogenic environment when the pressure dispenser exerts downward pressure toward the tip and/or releases the upward pressure toward the base of the syringe.

2. The system of claim 1 wherein the syringe is movably engaged within the syringe holder to move from a pick position to a print position.

3. The system of claim 1 wherein the biological sample is selected from a single cell, multiple cells, aggregates of cells, germplasm, embryos or oocytes.

4. The system of claim 1 wherein the biological sample is at least 0.01 mm in diameter.

5. The system of claim 1 wherein the biological sample is a droplet between about 0.1 μl and about 40.0 μl.

6. The system of claim 1 wherein the biological sample comprises laser absorbers and/or cryoprotective agents.

7. The system of claim 1 wherein the cooling platform is a high throughput system comprising two or more syringes with tips for picking and printing multiple biological samples.

8. The system of claim 1 further comprising a sorting station, wherein the sorting station comprises a sorting device with channels sized for flow of the biological samples in a fluid, a light source, a detector and a pressurized air tank operably connected to the detector and a buffer reservoir, wherein the detector can detect a vitrified sample from a unvitrified sample and the pressurized air tank operably connected to send a pulse of pressurized air to the buffer reservoir through an airline resulting in a pulse of buffer fluid entering the channel in the sorting station, wherein the sorting station is a microfluidics based sorting station and wherein the sorting station sorts the biological sample at a cryogenic temperature.

9. The system of claim 1 further comprising a warming platform, the warming platform comprising a cryoscoop for removing the biological sample from a cryogenic environment, wherein the warming platform further comprises a laser for warming the biological sample from a cryogenic temperature to a desired temperature.

10. A method for cryopreservation of a biological sample comprising:
picking up the biological sample with a syringe having a tip, wherein the syringe is engaged in a syringe holder of a cooling platform, the syringe coupled to a pressure dispenser wherein the tip picks up the biological sample when the pressure dispenser exerts upward pressure from the tip toward the base of the syringe; and
printing the biological sample wherein the sample is printed when the pressure dispenser exerts downward pressure toward the tip and/or releases the upward pressure toward the base of the syringe, wherein the biological sample is printed into a cryogenic environment.

11. The method of claim 10 wherein the cooling platform is a high-throughput system comprising one or more syringes.

12. The method of claim 10 wherein about 20-400 biological samples are cryopreserved in 1 minute.

13. The method of claim 10 wherein the biological sample is printed onto a fibrous wicking material resting on the surface of a highly conductive material and wherein the highly conductive material and the fibrous wicking material are resting in a cryogenic coolant.

14. The method of claim 10 wherein the biological sample is selected from a single cell, multiple cells, aggregates of cells, embryos or oocytes.

15. The method of claim 10 wherein the biological sample is a droplet between about 0.1 μl and about 40.0 μl.

16. The method of claim 10 further comprising sorting the biological sample, wherein the sorting comprises separating vitrified biological samples from crystallized biological samples, wherein pressure is applied when vitrified or crystallized samples are detected by a detector to separate the vitrified biological samples from the crystallized biological samples.

17. The method of claim 16 wherein the sorting is performed with a microfluidic sorting system.

18. The method of claim 10 further comprising a method for warming the cryopreserved biological sample with a warming platform, wherein the warming method comprises removing the biological sample from a cryogenic environment by a cryoscoop and warming the biological sample with laser assisted warming.

19. A sorting station comprising a sorting device with channels sized for flow of biological samples in a fluid, a light source, a detector and a pressurized air tank operably connected to the detector and a buffer reservoir, wherein the detector can detect a vitrified sample from a unvitrified sample and the pressurized air tank operably connected to the detector to send a pulse of pressurized air to the buffer reservoir through an airline resulting in a pulse of buffer fluid entering the channel in the sorting station to alter the pathway of the biological sample in the channel closest to the distal end of the pulse of the buffer fluid.

20. The sorting station of claim 19 wherein the sorting station separates the vitrified samples and the unvitrified samples into different channels.
